(19) United States
(12) Patent Application Publication
(10) Pub. No.: US 2024/0195101 A1
(43) Pub. Date: Jun. 13, 2024

(54) CONNECTION STRUCTURE OF GROUND-FREE CABLE AND CONNECTION METHOD OF GROUND-FREE CABLE

(71) Applicant: DONGGUAN LUXSHARE TECHNOLOGIES CO., LTD, Dongguan City (CN)

(72) Inventor: Jinchuang LAN, Dongguan City (CN)

(73) Assignee: DONGGUAN LUXSHARE TECHNOLOGIES CO., LTD, Dongguan City (CN)

(21) Appl. No.: 18/534,001

(22) Filed: Dec. 8, 2023

(30) Foreign Application Priority Data
Dec. 9, 2022 (CN) 202211584706.8

(51) Int. Cl. H01R 13/10; H01R 12/53; H01R 13/6581

(52) U.S. Cl. CPC H01R 13/10; H01R 12/53; H01R 13/6581

(57) ABSTRACT

Provided are a connection structure of a ground-free cable and a connection method of a ground-free cable. The connection structure of a ground-free cable includes a ground-free cable and a conductive module. The ground-free cable includes a conductor, an insulating layer, a shielding layer, and an outer wrapping layer which are sequentially wrapped. The ground-free cable has an insertion terminal mating with the conductive module. The insertion terminal is configured as follows: a part of the conductor is exposed outside the insulating layer and forms a conductor insertion portion, and a part of the shielding layer and a part of the insulating layer are both exposed outside the outer wrapping layer and form a shielding insertion portion. A receptacle is provided on the conductive module. The shielding insertion portion and the conductor insertion portion are both inserted into the receptacle and are electrically connected to the conductive module.

### CROSS-REFERENCE TO RELATED APPLICATIONS

This application claims priority to Chinese patent application No. 202211584706.8 filed with the China National Intellectual Property Administration (CNIPA) on Dec. 9, 2022, the disclosure of which is incorporated herein by reference in its entirety.

### TECHNICAL FIELD

The present disclosure relates to the technical field of connectors and, in particular, to a connection structure of a ground-free cable and a connection method of a ground-free cable.

### BACKGROUND

An existing ground-free cable is grounded through a connection between a conductive module and a shielding medium wrapping a conductor. Moreover, the end of the ground-free cable connected to the conductive module is usually parallel to the conductive module, and the ground-free cable and the conductive module are connected through flat welding. The shielding medium is usually made of aluminum foil with a relatively low strength. To ensure the stability of the connection between the shielding medium and the conductive module, a fixing member usually needs to be provided in the related art for compressing the shielding medium onto the conductive module, and the shielding medium is electrically connected to the conductive module through an additional conductive medium.

For example, the previous Chinese patent with the application number CN202210484482.7 discloses a connection structure of a ground-free high-speed cable, a shielding medium of the ground-free high-speed cable and a common-ground leading region are fittingly connected through deformation of a conductive medium to form a ground-signal short connection, and the ground-free high-speed cable is connected to a conductive module through a shielding piece (a fixing member) to restrain the conductive medium and the common-ground leading region. However, in such a solution, the shielding piece is additionally provided, resulting in a relatively great number of components and low assembly efficiency. Moreover, the transmission between the shielding medium and the conductive module needs to be achieved indirectly through the conductive medium, resulting in a relatively long transmission link and relatively huge transmission losses.

### SUMMARY

The present disclosure provides a connection structure of a ground-free cable. The connection structure includes a ground-free cable and a conductive module. The ground-free cable includes a conductor, an insulating layer wrapped around the outside of the conductor, a shielding layer wrapped around the outside of the insulating layer, and an outer wrapping layer wrapped around the outside of the shielding layer. The ground-free cable has an insertion terminal mating with the conductive module. The insertion terminal is configured as follows: a part of the conductor is exposed outside the insulating layer and forms a conductor insertion portion, and a part of the shielding layer and a part of the insulating layer are both exposed outside the outer wrapping layer and form a shielding insertion portion. A receptacle is provided on the conductive module.

The shielding insertion portion and the conductor insertion portion are each inserted into the receptacle. The shielding insertion portion and the conductor insertion portion are electrically connected to the conductive module.

In an embodiment of the connection structure, the receptacle includes a first receptacle recessed on an end surface of the conductive module and a second receptacle recessed on a bottom surface of the first receptacle. The shielding insertion portion is inserted into the first receptacle. The conductor insertion portion is inserted into the second receptacle.

In an embodiment of the connection structure, the aperture of the second receptacle is smaller than the aperture of the first receptacle. The shielding insertion portion abuts the bottom surface of the first receptacle.

In an embodiment of the connection structure, the shielding insertion portion and the conductor insertion portion are each soldered to the conductive module.

In an embodiment of the connection structure, the second receptacle penetrates the conductive module.

In an embodiment of the connection structure, the receptacle further includes a solder groove recessed on the end surface of the conductive module. The solder groove communicates with the first receptacle.

In an embodiment of the connection structure, multiple solder grooves are provided. The multiple solder grooves are disposed uniformly in the circumferential direction of the first receptacle.

In an embodiment of the connection structure, the length of the part of the shielding layer extending out of the outer wrapping layer is equal to the length of the part of the insulating layer extending out of the outer wrapping layer.

In an embodiment of the connection structure, two conductors are provided. The insulating layer is disposed outside each of the two conductors and located inside the shielding layer.

In an embodiment of the connection structure, the length direction of the ground-free cable is perpendicular to the end surface of the conductive module.

Another object of the present disclosure is to provide a connection method of a ground-free cable used for fixedly connecting the ground-free cable and the conductive module in the connection structure of a ground-free cable. The method includes the steps described below.

The shielding insertion portion and the conductor insertion portion are each inserted into the receptacle.

The ground-free cable is soldered to the conductive module.

In an embodiment of the connection method, the step of soldering the ground-free cable to the conductive module includes the steps described below.

A solder is placed on a solder placement position on the upper surface of the conductive module, and the solder surrounds at least a part of the outer wrapping layer.

The solder is melted and enabled to enter the receptacle.

The shielding insertion portion and the conductor insertion portion are welded to the conductive module after the cooling and solidification of the melted solder.

In an embodiment of the connection method, the melted solder enters the solder groove of the receptacle.

In an embodiment of the receding connection method, the solder is in a solid state before being melted, and the solder surrounds at least ¾ circle of the outer wrapping layer.

In an embodiment of the receding connection method, the solder is in a circular shape or a U shape before being melted.

The present disclosure has the beneficial effects below.

The present disclosure provides a connection structure of a ground-free cable and a connection method of a ground-free cable. In the connection structure of the ground-free cable, the receptacle is provided on the conductive module, the shielding insertion portion and the conductor insertion portion are both inserted into the receptacle, and the shielding insertion portion and the conductor insertion portion are electrically connected to the conductive module. In this manner, the shielding insertion portion and the conductor insertion portion are limited, ensuring a stable relative position of the shielding insertion portion and the conductor insertion portion relative to the conductive module. Compared with the related art, no additional shielding piece needs to be provided, effectively reducing the number of components and improving assembly efficiency. Moreover, the shielding insertion portion is electrically connected to the conductive module directly. Compared with the related art, no additional conductive medium needs to be provided, resulting in a short transmission link and effectively reducing transmission losses.

### BRIEF DESCRIPTION OF DRAWINGS

FIG. 1 is a structural view of a connection structure of a ground-free cable according to an embodiment of the present disclosure;

FIG. 2 is an exploded view of the connection structure of a ground-free cable according to the embodiment of the present disclosure;

FIG. 3 is a partial view of a conductive module in the connection structure of a ground-free cable according to the embodiment of the present disclosure;

FIG. 4 is a structural view of a ground-free cable in the connection structure of a ground-free cable according to the embodiment of the present disclosure; and

FIG. 5 is a sectional view of the ground-free cable in the connection structure of a ground-free cable according to the embodiment of the present disclosure.

### DETAILED DESCRIPTION

The technical schemes of the present disclosure are described clearly and completely hereinafter in conjunction with drawings. Apparently, the described embodiments are part, not all, of embodiments of the present disclosure. Based on the embodiments of the present disclosure, all other embodiments obtained by those of ordinary skill in the art are within the scope of the present disclosure on the premise that no creative work is done.

In the description of the present disclosure, it is to be noted that orientations or position relations indicated by terms such as “center”, “upper”, “lower”, “left”, “right”, “vertical”, “horizontal”, “in” and “out” are based on the drawings. These orientations or position relations are intended only to facilitate and simplify the description of the present disclosure and not to indicate or imply that a device or element referred to must have such particular orientations or must be configured or operated in such particular orientations. Thus, these orientations or position relations are not to be construed as limiting the present disclosure. Additionally, terms such as “first” and “second” are used only for the purpose of description and are not to be construed as indicating or implying relative importance. Terms “first position” and “second position” are two different positions. Moreover, when the first feature is described as “on”, “above” or “over” the second feature, the first feature is right on, above or over the second feature or the first feature is obliquely on, above or over the second feature, or the first feature is simply at a higher level than the second feature. When the first feature is described as “under”, “below” or “underneath” the second feature, the first feature is right under, below or underneath the second feature, the first feature is obliquely under, below or underneath the second feature, or the first feature is simply at a lower level than the second feature.

In the description of the present disclosure, it is to be noted that unless otherwise expressly specified and limited, the term “mounted”, “connected to each other” or “connected” should be construed in a broad sense as securely connected, detachably connected or integrally connected; mechanically connected or electrically connected; directly connected to each other or indirectly connected to each other via an intermediary; or interconnected between two components. For those of ordinary skill in the art, specific meanings of the preceding terms in the present disclosure may be construed based on specific situations.

Embodiments of the present disclosure are described in detail below, and examples of the embodiments are illustrated in the drawings, where the same or similar reference numerals indicate the same or similar elements or elements having the same or similar functions. The embodiments described below with reference to the drawings are merely exemplary and intended to explain the present disclosure, and are not to be construed as limiting the present disclosure.

In the related art, a shielding medium of a ground-free high-speed cable and a common-ground leading region are fittingly connected through the deformation of a conductive medium to form a ground-signal short connection, and the ground-free high-speed cable is connected to a conductive module through a shielding piece to restrain the conductive medium and the common-ground leading region. However, in such a solution, the shielding piece needs to be provided additionally, resulting in a relatively great number of components and low assembly efficiency. Moreover, the transmission between the shielding medium and the conductive module needs to be achieved indirectly through the conductive medium, resulting in a relatively long transmission link and relatively huge transmission losses.

In this regard, the embodiment provides a connection structure of a ground-free cable.

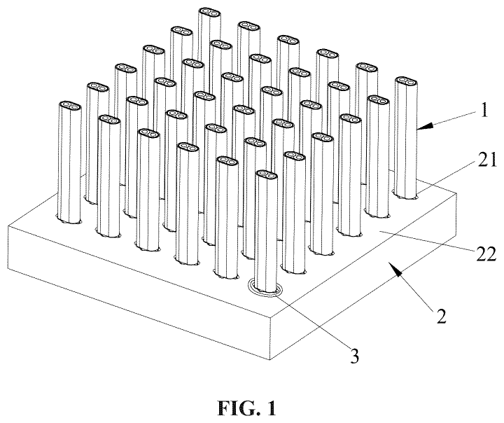

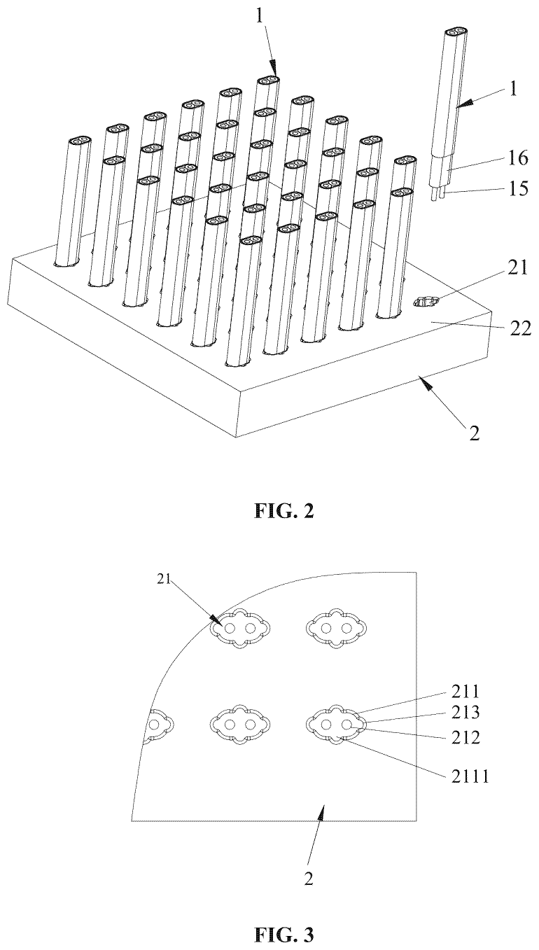

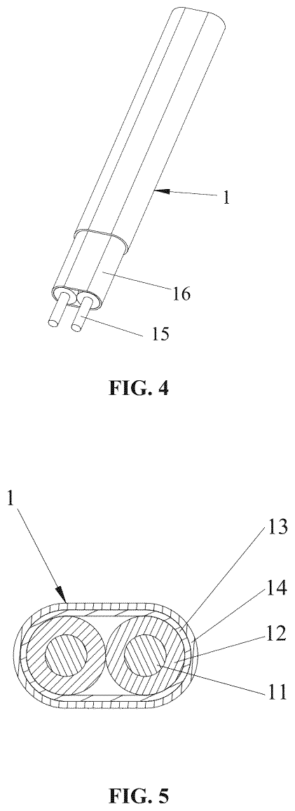

As shown in FIGS. 1 to 5, the connection structure of a ground-free cable includes the ground-free cable 1 and a conductive module 2. The ground-free cable 1 is configured to be connected to the conductive module 2, and the ground-free cable 1 is configured to be connected to an electronic component so that the signal transmission between the electronic component and the conductive module 2 is implemented. The embodiment exemplifies the scheme in which the conductive module 2 is a printed circuit board (PCB). In another embodiment, the conductive module 2 may be, for example, a terminal wiring structure of a connector.

In the embodiment, the ground-free cable 1 includes a conductor 11, an insulating layer 12 wrapped around the outside of the conductor 11, a shielding layer 13 wrapped around the outside of the insulating layer 12, and an outer wrapping layer 14 wrapped around the outside of the shielding layer 13. The outer wrapping layer 14 is configured to protect the shielding layer 13, the insulating layer 12, and the conductor 11 inside the outer wrapping layer 14 as a whole. The shielding layer 13 is made of a metal material, for example, aluminum foil and copper mesh, and is configured to prevent a signal transmitted by the conductor 11 from being subjected to external electromagnetic interference. The insulating layer 12 is made of an insulating material and is configured to insulate and protect the conductor 11. The conductor 11 is configured to transmit signals.

The ground-free cable 1 has an insertion terminal mating with the conductive module 2. The insertion terminal is configured as follows: a part of the conductor 11 is exposed outside the insulating layer 12 and forms a conductor insertion portion 15, and a part of the shielding layer 13 and a part of the insulating layer 12 are both exposed outside the outer wrapping layer 14 and form a shielding insertion portion 16. The conductive module 2 is provided with a receptacle 21. The shielding insertion portion 16 and the conductor insertion portion 15 are all inserted into the receptacle 21. The shielding insertion portion 16 and the conductor insertion portion 15 are both electrically connected to the conductive module 2. The shielding insertion portion 16 is limited by the receptacle 21 provided on the conductive module 2 so that a stable relative position of the shielding insertion portion 16 against the conductive module 2. Therefore, the shielding piece in the related art does not need to be provided, effectively reducing the number of components and improving assembly efficiency. Moreover, the shielding insertion portion 16 may be electrically connected to the conductive module 2 directly without providing the conductive medium in the related art, the transmission link is short, and the transmission losses can be effectively reduced.

The receptacle 21 includes a first receptacle 211 recessed on the end surface 22 of the conductive module 2 and a second receptacle 212 recessed on the bottom surface 2111 of the first receptacle 211. The shielding insertion portion 16 is inserted into the first receptacle 211. The conductor insertion portion 15 is inserted into the second receptacle 212. In this manner, the shielding insertion portion 16 can be limited by the first receptacle 211, and the conductor insertion portion 15 can be limited by the second receptacle 212, ensuring the stable mating between the insertion terminal and the conductive module 2. In an embodiment, the aperture of the second receptacle 212 is smaller than the aperture of the first receptacle 211, and the shielding insertion portion 16 abuts the bottom surface 2111 of the first receptacle 211. The first receptacle 211 and the second receptacle 212 form the structure of a stepped hole, which further improves the stability of the mating between the insertion terminal and the conductive module 2. Further, both the shielding insertion portion 16 and the conductor insertion portion 15 may be soldered to the conductive module 2. This manner can ensure that the conductor insertion portion 15 and the shielding insertion portion 16 are more stably connected to the conductive module 2 and are not easily separated apart, thereby ensuring the stable electrical connection. Tin soldering may be adopted for soldering.

In an embodiment, the second receptacle 212 penetrates the conductive module 2. The aperture of the second receptacle 212 may match the outer diameter of the conductor insertion portion 15, and one end of the conductor insertion portion 15 partially extends out of the second receptacle 212; then the conductor 11 is soldered to the conductive module 2. Alternatively, the aperture of the second receptacle 212 is greater than the outer diameter of the conductor insertion portion 15, and the solder is filled in a gap between the second receptacle 212 and the conductor insertion portion 15 to implement soldering.

In an embodiment, the receptacle 21 further includes a solder groove 213 recessed on the end surface 22 of the conductive module 2. The solder groove 213 communicates with the first receptacle 211. Soldering tin may be accommodated in the solder groove 213 so that the soldering between the shielding insertion portion 16 and the conductive module 2 can be implemented. In an embodiment, multiple solder grooves 213 are provided. The multiple solder grooves 213 are disposed uniformly in the circumferential direction of the first receptacle 211. In this manner, it can be ensured that soldering is implemented at multiple positions between the shielding insertion portion 16 and the conductive module 2, so that the stability of the connection is ensured. Moreover, multiple soldering positions are disposed uniformly, ensuring the stable stress between the shielding insertion portion 16 and the conductive module 2. Further, the aperture of the first receptacle 211 is equal to the outer diameter of the shielding insertion portion 16, so that the effect of limiting the shielding insertion portion 16 by the first receptacle 211 is ensured.

In an embodiment, the length of the part of the shielding layer 13 extending out of the outer wrapping layer 14 is equal to the length of the part of the insulating layer 12 extending out of the outer wrapping layer 14. In this manner, the shielding layer 13 is supported through the insulating layer 12, avoiding the deformation of the shielding layer 13.

In the embodiment, two conductors 11 are provided. The outside of each conductor 11 is provided with the insulating layer 12, and the insulating layers 12 of both conductors 11 are located inside the shielding layer 13. In another embodiment, one or more conductors 11 may be provided according to requirements. For example, in some embodiments, one conductor 11 is disposed in the ground-free cable 1, and correspondingly, one second receptacle 212 is provided in the receptacle 21 for insertion. In some embodiments, three or more conductors 11 are disposed in the ground-free cable 1, and correspondingly, three or more second receptacles 212 are provided in the receptacle 21 for insertion.

In an embodiment, the length direction of the ground-free cable 1 is perpendicular to the end surface 22 of the conductive module 2. In this manner, the perpendicular insertion between the insertion terminal and the receptacle 21 can be implemented, thus the perpendicular soldering between the insertion terminal and the receptacle 21 can be implemented.

The embodiment further provides a connection method of a ground-free cable used for fixedly connecting the ground-free cable 1 and the conductive module 2 of the connection structure of a ground-free cable. The method includes the steps described below.

The shielding insertion portion 16 and the conductor insertion portion 15 are inserted into the receptacle 21.

The ground-free cable 1 is soldered to the conductive module 2.

The ground-free cable 1 and the conductive module 2 are connected through welding, ensuring the stable connection between the ground-free cable 1 and the conductive module 2 and ensuring convenient operations.

In an embodiment, soldering the ground-free cable 1 to the conductive module 2 includes the steps described below.

The solder is placed on a solder placement position 3 on the upper surface of the conductive module 2, and the solder surrounds at least a part of the outer wrapping layer 14. The solder may surround ¾ circle, more than ¾ circle, or the entire circle of the outer wrapping layer to ensure the firmness and stability of the soldering.

The solder is melted by soldering equipment to enter the receptacle 21. The solder contacts the shielding insertion portion 16, the conductor insertion portion 15 and the inner wall of the receptacle 21. After the melted solder cools and solidifies, both the shielding insertion portion 16 and the conductor insertion portion 15 are soldered to the conductive module 2.

In an embodiment, according to the preceding description of the structure of the first receptacle 211, to ensure the connection between the conductive module 2 and the shielding insertion portion 16, the melted solder enters solder grooves 213 of the receptacle 21. Multiple solder grooves 213 are disposed uniformly in the circumferential direction of the first receptacle 211. In this manner, it can be ensured that soldering is implemented at multiple positions between the shielding insertion portion 16 and the conductive module 2, so as to ensure the stability of the connection. Moreover, the multiple soldering positions are disposed uniformly, ensuring the stable stress between the shielding insertion portion 16 and the conductive module 2. The melted solder may be soldering tin.

The melted solder may flow into the second receptacle 212 through the solder grooves 213 so that the conductor insertion portion 15 is soldered to the conductive module 2.

In the embodiment, the solder is in a solid state before being melted, and the solder is in a circular shape or a U shape before being melted.

If the solder is in a U shape, the solder may be heated and melted by a U-shaped soldering head. The U-shaped soldering head corresponds to the U-shaped solder, and multiple U-shaped soldering heads may be integrated into an integrated soldering head. This integrated soldering head can simultaneously solder multiple pairs of ground-free cables 1 and conductive modules 2, further improving the efficiency of soldering operations.

Apparently, the preceding embodiments of the present disclosure are only illustrative of the present disclosure and are not intended to limit the implementations of the present disclosure. For those of ordinary skill in the art, changes or alterations in other different forms may also be made based on the preceding description. All implementations cannot be and do not need to be exhausted herein. Any modifications, equivalent substitutions and improvements made within the spirit and principle of the present disclosure fall within the scope of the claims of the present disclosure.

What is claimed is:

1. A connection structure of a ground-free cable, comprising a ground-free cable and a conductive module, wherein the ground-free cable comprises a conductor, an insulating layer wrapped around an outside of the conductor, a shielding layer wrapped around an outside of the insulating layer, and an outer wrapping layer wrapped around an outside of the shielding layer; the ground-free cable has an insertion terminal mating with the conductive module; the insertion terminal is configured as follows: a part of the conductor is exposed outside the insulating layer and forms a conductor insertion portion, and a part of the shielding layer and a part of the insulating layer are both exposed outside the outer wrapping layer and form a shielding insertion portion; and a receptacle is provided on the conductive module; wherein
the shielding insertion portion and the conductor insertion portion are each inserted into the receptacle, and the shielding insertion portion and the conductor insertion portion are each electrically connected to the conductive module.

2. The connection structure according to claim 1, wherein the receptacle comprises a first receptacle recessed on an end surface of the conductive module and a second receptacle recessed on a bottom surface of the first receptacle, the shielding insertion portion is inserted into the first receptacle, and the conductor insertion portion is inserted into the second receptacle.

3. The connection structure according to claim 2, wherein an aperture of the second receptacle is smaller than an aperture of the first receptacle, and the shielding insertion portion abuts the bottom surface of the first receptacle.

4. The connection structure according to claim 2, wherein the shielding insertion portion and the conductor insertion portion are each connected to the conductive module through welding.

5. The connection structure according to claim 4, wherein the second receptacle penetrates the conductive module.

6. The connection structure according to claim 4, wherein the receptacle further comprises a solder groove recessed on the end surface of the conductive module, and the solder groove communicates with the first receptacle.

7. The connection structure according to claim 6, wherein a plurality of solder grooves are provided, and the plurality of solder grooves are disposed uniformly in a circumferential direction of the first receptacle.

8. The connection structure according to claim 1, wherein the part of the shielding layer extending out of the outer wrapping layer has an equal length with the part of the insulating layer extending out of the outer wrapping layer.

9. The connection structure according to claim 1, wherein two conductors are provided, and an outside of each of the two conductors is provided with the insulating layer located inside the shielding layer.

10. The connection structure according to claim 1, wherein a length direction of the ground-free cable is perpendicular to the end surface of the conductive module.

11. A connection method of a ground-free cable, being used for fixedly connecting the ground-free cable and a conductive module both included in a connection structure, wherein the ground-free cable comprises a conductor, an insulating layer wrapped around an outside of the conductor, a shielding layer wrapped around an outside of the insulating layer, and an outer wrapping layer wrapped around an outside of the shielding layer; the ground-free cable has an insertion terminal mating with the conductive module; the insertion terminal is configured as follows: a part of the conductor is exposed outside the insulating layer and forms a conductor insertion portion, and a part of the shielding layer and a part of the insulating layer are both exposed outside the outer wrapping layer and form a shielding insertion portion; and a receptacle is provided on the conductive module; wherein the shielding insertion portion and the conductor insertion portion are each inserted into the receptacle, and the shielding insertion portion and the conductor insertion portion are each electrically connected to the conductive module; and
wherein the method comprises:
inserting each of the shielding insertion portion and the conductor insertion portion into the receptacle; and
soldering the ground-free cable to the conductive module.

12. The connection method according to claim 11, wherein soldering the ground-free cable to the conductive module comprises:
placing a solder on a solder placement position on an upper surface of the conductive module, wherein the solder surrounds at least a part of the outer wrapping layer;
melting the solder to enable the solder to enter the receptacle; and
soldering both the shielding insertion portion and the conductor insertion portion to the conductive module after cooling and solidification of the melted solder.

13. The connection method according to claim 12, wherein the melted solder enters the solder groove of the receptacle.

14. The connection method according to claim 12, wherein the solder is in a solid state before being melted, and the solder surrounds at least ¾ circle of the outer wrapping layer.

15. The connection method according to claim 14, wherein the solder is in a circular shape or a U shape before being melted.

16. The connection method according to claim 11, wherein the receptacle comprises a first receptacle recessed on an end surface of the conductive module and a second receptacle recessed on a bottom surface of the first receptacle, the shielding insertion portion is inserted into the first receptacle, and the conductor insertion portion is inserted into the second receptacle.

17. The connection method according to claim 16, wherein an aperture of the second receptacle is smaller than an aperture of the first receptacle, and the shielding insertion portion abuts the bottom surface of the first receptacle.

18. The connection method according to claim 16, wherein the shielding insertion portion and the conductor insertion portion are each connected to the conductive module through welding.

19. The connection method according to claim 18, wherein the second receptacle penetrates the conductive module.

20. The connection method according to claim 18, wherein the receptacle further comprises a solder groove recessed on the end surface of the conductive module, and the solder groove communicates with the first receptacle.
